(19) United States
(12) Patent Application Publication
(10) Pub. No.: US 2016/0070156 A1
(43) Pub. Date: Mar. 10, 2016

(54) Collapsible Extension Along With Image Capture Device And Case Incorporating The Same

(71) Applicants: Shahar Alster, Sunnyvale, CA (US); Ori Cohen, Palo Alto, CA (US)

(72) Inventors: Shahar Alster, Sunnyvale, CA (US); Ori Cohen, Palo Alto, CA (US)

(21) Appl. No.: 14/617,406

(22) Filed: Feb. 9, 2015

Related U.S. Application Data
(60) Provisional application No. 62/047,816, filed on Sep. 9, 2014.

(51) Int. Cl. G03B 17/56; G03B 17/04

(52) U.S. Cl. CPC G03B 17/563; G03B 17/561; G03B 17/04

(57) ABSTRACT

An image capture device case comprising a cover and a collapsible extension coupled to the cover. The cover comprises a cover panel, a surrounding sidewall extending from the cover panel to form a device opening to receive an image capture device, and a recessed region formed in the cover panel opposite the device opening. The extension comprises first, second, and third segments. The first segment includes a first relief and is rotatably coupled to the cover adjacent the recessed region, wherein the first segment is sized to fit at least partially within the recessed region. The second segment is rotatably coupled to the first segment and includes a second relief, wherein the second segment is sized to fit at least partially within the first relief. The third segment is rotatably coupled to the second segment, wherein the third segment is sized to fit at least partially within the second relief.

### CROSS-REFERENCE TO RELATED APPLICATION

This application claims the benefit of U.S. Provisional Application No. 62/047,816, filed Sep. 9, 2014, the disclosure of which is hereby incorporated by reference in its entirety.

### BACKGROUND OF THE INVENTION

A self-portrait photograph is a photograph taken of oneself with an image capture device, such as a camera, digital camera, camera phone, or tablet. People have been taking self-portrait photographs since the early 1800s. However, since the advent of social networking, a self-portrait is now commonly referred to as a “selfie.” Most selfies are taken with a camera phone held at arm's length rather than using a timer and tripod as was done in the past.

Selfies may be of a single individual or, in other cases, of a group of people along with a background of interest, for example. The length of a person's arm limits the field of view that can be captured in a selfie. Existing devices have attempted to address this limitation by providing an extension that attaches to the image capture device thereby allowing the photographer to hold the camera further away from their body to take a photograph.

However, existing devices can be bulky and must be attached to the image capture device prior to taking a photograph. Furthermore, these devices are separate items that must be carried separately and are not always available when a photographer wishes to take a selfie. Accordingly, there is a need for an extension that is more convenient and easy to use than existing devices.

### BRIEF SUMMARY OF THE INVENTION

Provided herein are collapsible extensions for use with camera phones, camera phone cases incorporating collapsible extensions, and camera phones or other image capture devices incorporating collapsible extensions. In a representative embodiment, a collapsible extension can be attached directly to an image capture device or to a capture device case. In an embodiment, the collapsible extension for use with an image capture device comprises two or more hinged segments moveable with respect to each other between a collapsed configuration and an extended configuration, wherein one of the two or more segments is attachable to an image capture device.

In some embodiments, the two or more hinged segments nest together when in the collapsed configuration. The collapsible extension can further comprise a case sized and configured to at least partially surround an image capture device and the case can be attached to one of the two or more segments. In some embodiments, the case includes a recessed region sized and configured to receive the two or more hinged segments when in the collapsed configuration. In some embodiments, the collapsible extension comprises three hinged segments that can rotate in alternating directions and nest together when in the collapsed configuration.

In another representative embodiment, an image capture device case incorporating a collapsible extension includes a case configured to at least partially surround an image capture device and a collapsible extension coupled to the case. The collapsible extension includes two or more collapsible segments rotatable between a collapsed configuration and an extended configuration, wherein the two or more hinged segments nest together when in the collapsed configuration.

In some embodiments, the two or more collapsible segments are hinged to each other. In some embodiments, the collapsible segments stack against the case when in the collapsed configuration. In some embodiments, the case includes a recessed region sized and configured to receive the two or more hinged segments when in the collapsed configuration. In some embodiments, the collapsible extension comprises three hinged segments. In some embodiments, the three hinged segments rotate in alternating directions and nest together when in the collapsed configuration. In some embodiments, the three hinged segments are each coupled to each other by a corresponding pair of pins.

In a further representative embodiment, an image capture device case comprises a cover and an extension coupled to the cover and moveable between a collapsed configuration and an extended configuration. The cover comprises a cover panel, a surrounding sidewall extending from the cover panel to form a device opening sized and configured to receive an image capture device, and a recessed region formed in the cover panel opposite the device opening. The extension comprises first, second, and third segments. The first segment includes a first relief and is rotatably coupled to the cover adjacent the recessed region, wherein the first segment is sized to fit at least partially within the recessed region when in the collapsed configuration. The second segment is rotatably coupled to the first segment and includes a second relief, wherein the second segment is sized to fit at least partially within the first relief when in the collapsed configuration. The third segment is rotatably coupled to the second segment, wherein the third segment is sized to fit at least partially within the second relief when in the collapsed configuration.

In some embodiments, the first segment rotates with respect to the cover about a first axis, the second segment rotates with respect to the first segment about a second axis, and the third segment rotates with respect to the second segment about a third axis, wherein the first, second, and third axes are parallel with respect to each other. In some embodiments, at least the case, the first segment, and the second segment are each coupled to each other by a corresponding pair of pins extending along the first and second axes, respectively. In some embodiments, each pin includes a plurality of teeth engaged with corresponding mating teeth formed on the case and the first segment.

These and other aspects of the disclosed technology will be apparent after consideration of the Detailed Description and Figures herein. It is to be understood, however, that the scope of the invention shall be determined by the claims as issued and not by whether given subject matter addresses any or all issues noted in the background or includes any features or aspects recited in this summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various view unless otherwise specified.

FIG. 1 is a perspective view of an image capture device including a collapsible extension according to a representative embodiment.

FIG. 2 is a perspective view of the image capture device shown in FIG. 1 with the collapsible extension positioned in a collapsed configuration.

FIG. 3 is an image capture device including a collapsible extension according to another representative embodiment, positioned in a portrait orientation.

FIG. 4 is a perspective view of an image capture device including a collapsible extension according to a further representative embodiment.

FIG. 5 is an image capture device incorporating a collapsible extension comprising telescoping segments according to yet another representative embodiment.

FIG. 6 is a perspective view of the image capture device shown in FIG. 5 with the collapsible extension positioned in an extended configuration.

FIG. 7 is a perspective view of the image capture device shown in FIGS. 5 and 6 illustrating articulation of the collapsible extension.

FIG. 8 is a perspective view of an image capture device with an integrated collapsible extension according to another representative embodiment.

FIG. 9 is a front view of the image capture device shown in FIG. 8.

FIG. 10 is a perspective view of an image capture device case according to a representative embodiment shown in the collapsed configuration and as viewed from the front.

FIG. 11 is a perspective view of the image capture device case shown in FIG. 10 as viewed from the back.

FIG. 12 is a perspective view of the image capture device case shown in FIGS. 10 and 11 in the extended configuration as viewed from the front.

FIG. 13 is a perspective view of the image capture device case shown in FIGS. 10-12 as viewed from the back.

FIG. 14 is a partial perspective view illustrating hinged extension segments.

FIG. 15 is a partial side view in cross-section taken about line 15-15 in FIG. 14.

FIG. 16 is a perspective view of a hinge pin.

FIG. 17 is a partial perspective view illustrating the interlocking teeth of a hinge.

### DETAILED DESCRIPTION OF THE INVENTION

Embodiments are described more fully below with reference to the accompanying figures, which form a part hereof and show, by way of illustration, specific representative embodiments. These embodiments are disclosed in sufficient detail to enable those skilled in the art to practice the disclosed technology. However, embodiments may be implemented in many different forms and should not be construed as being limited to the embodiments set forth herein. The following detailed description is, therefore, not to be taken in a limiting sense.

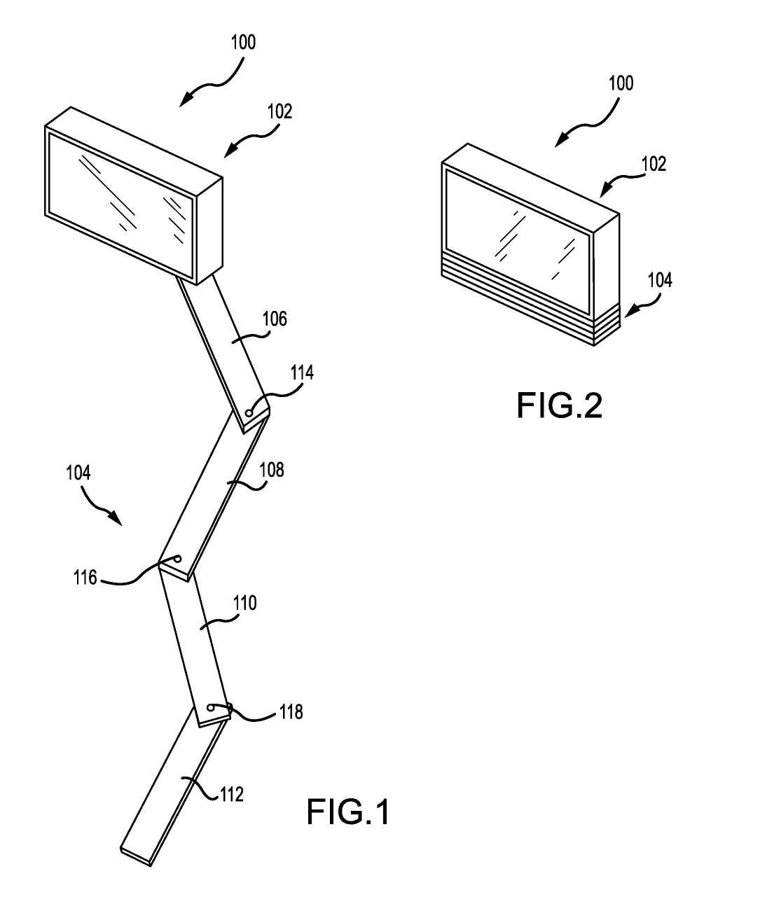

FIG. 1 illustrates an image capture device incorporating a collapsible extension 100, according to a representative embodiment. A collapsible extension 104 is attached to a camera phone or other image capture device 102, such as a camera, digital camera, or tablet, for example. Alternatively, collapsible extension 104 is attached to a case configured to surround an image capture device. Thus, reference numeral 102 may refer to an image capture device or a case for an image capture device.

Collapsible extension 104 includes a plurality of segments 106, 108, 110, and 112. The segments are moveable between an extended configuration as shown in FIG. 1, and a collapsed configuration as shown in FIG. 2. In this embodiment, the segments rotate about suitable pivot pins 114, 116, and 118. Accordingly, the segments collapse or fold in a scissor-like fashion such that they may be stowed adjacent the case or camera phone 102, as shown in FIG. 2. Segments 106, 108, 110, and 112 and pivot pins 114, 116, and 118 can be comprised of any suitable material, such as plastic, metal, wood, composite materials, and the like. The collapsible extension can be attached to the camera phone or case by any suitable structure, such as a threaded fastener, a rivet, adhesive, cooperative hook and loop fasteners, magnets, and the like. It should be understood that although the various embodiments herein show four segments, more or fewer segments can be used in the collapsible extensions.

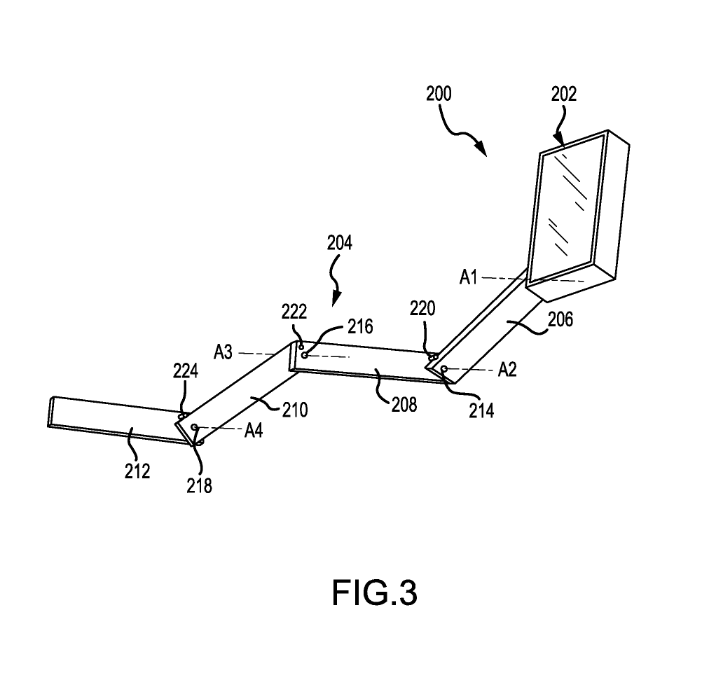

FIG. 3 illustrates a camera phone or case incorporating a collapsible extension 200, according to another representative embodiment. Collapsible extension 204 is similar to that shown in FIGS. 1 and 2, and is attached to camera phone or case 202. Collapsible extension 204 is configured to support a camera phone in a portrait orientation as well as a landscape orientation. In this embodiment, collapsible extension 204 includes segments 206, 208, 210, and 212, which are pivotably attached to each other via pivot pins 214, 216, and 218. As illustrated, each segment rotates about an axis, all of which are parallel to each other. Axis A₁ represents the attachment location of the collapsible extension 204 to the camera phone 202. Axes A₂, A₃, and A₄ are all parallel to axis A₁. Each axis extends through the thickness of its respective segment; thus, the segments rotate and collapse with respect to each other in a scissor-like fashion.

It can be appreciated from the figure that camera phone 202 is oriented in a portrait orientation as opposed to the landscape orientation of FIGS. 1 and 2. In order to support the weight of a camera phone 202 in the portrait orientation, collapsible extension 204 is configured with sufficient friction about the pivot pins to prevent the segments from rotating (e.g., collapsing) with respect to each other. Friction can be provided with an appropriate friction fit between the pivot pins and segments. In addition to or in lieu of friction, stop pins 220, 222, and 224 may be provided along the segments to limit rotation of the segments with respect to each other in order to facilitate extending the camera phone 202 in a portrait orientation. Detents may be provided between the rotating portions of the segments as another alternative structure to prevent the segments from rotating beyond their fully extended configuration.

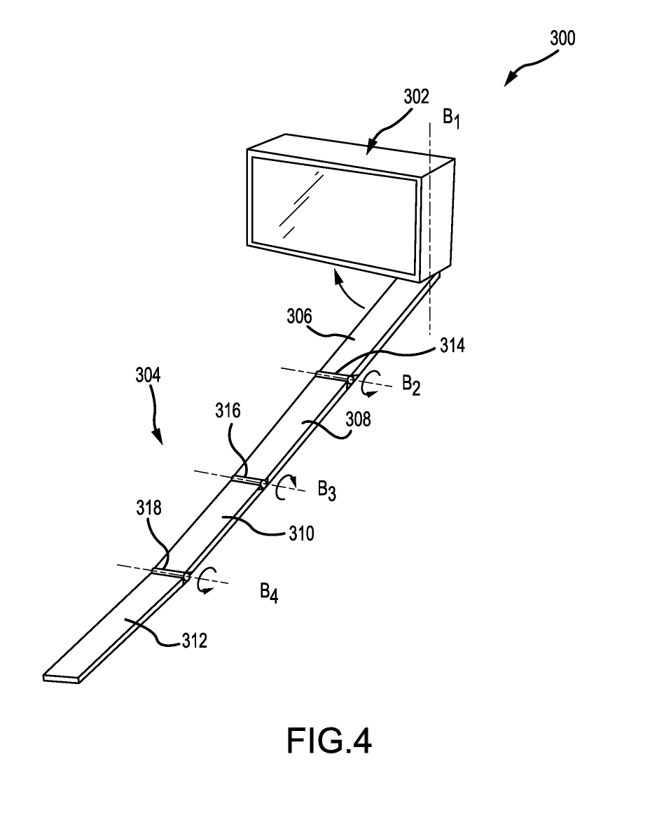

FIG. 4 illustrates a camera phone incorporating a collapsible extension 300 according to a further representative embodiment. In this embodiment, collapsible extension 304 includes a plurality of segments 306, 308, 310, and 312 that are hinged to each other about pins 314, 316, and 318. One skilled in the art will recognize that the hinges corresponding to pins 314, 316, and 318 are configured such that they can only rotate approximately 180°. The segments collapse with respect to each other in a hinge-like fashion about axes B₂, B₃, and B₄, which extend along the width of the segments as shown in the figure. The segments collapse against each other in alternating rotation. The collapsible extension 304 rotates with respect to the camera phone or case 302 about axis B₁. Axis B₁ is orthogonal to axes B₂, B₃, and B₄.

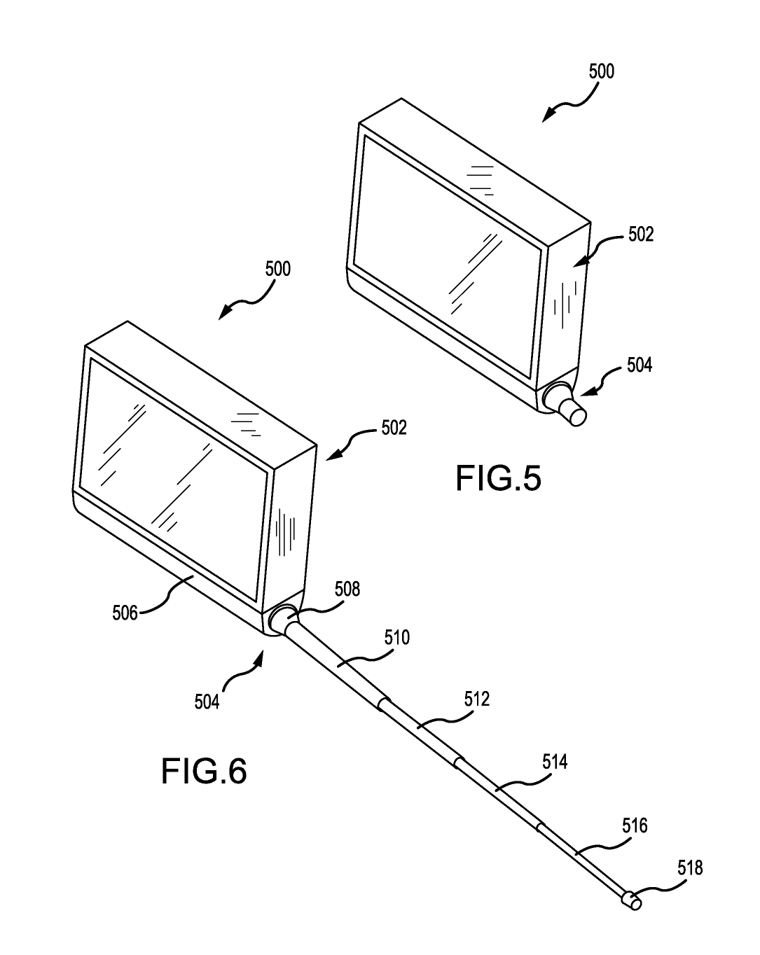

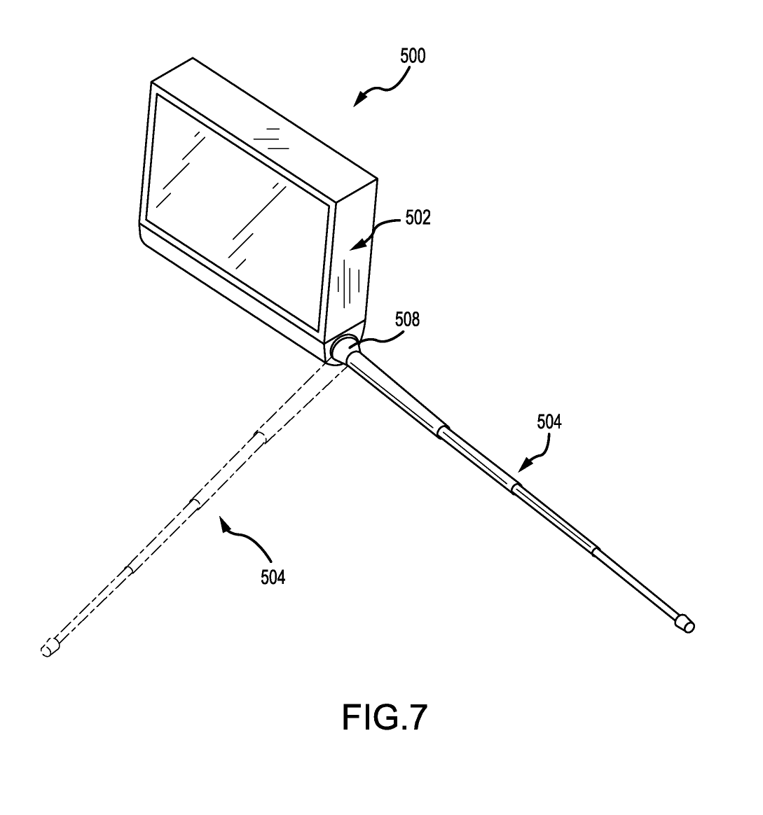

FIG. 5 illustrates an image capture device including a collapsible extension 500 according to another representative embodiment. In this embodiment, the collapsible extension 504 is attachable to the image capture device or case 502. Alternatively, the collapsible extension can be integral with the case or camera phone 502. As shown in FIG. 6, the collapsible extension 504 is comprised of a plurality of nested cylindrical segments 510, 512, 514, and 516. The collapsible extension 504 may also include a handle 518 to facilitate extending the collapsible extension from a collapsed configuration (FIG. 5) to an extended configuration (FIG. 6). In some embodiments, the collapsible extension 504 further includes a ball joint 508 interconnecting the collapsible segments to the image capture device or case 502. Ball joint 508 allows the collapsible extension 504 to pivot in relation to the camera phone or case 502. The collapsible extension 504 may further include a housing 506 to contain the collapsible segments of the telescoping collapsible segments when in the collapsed state. Ball joint 508 interconnects the collapsible segments to the image capture device 502, whereby the collapsible segments are pivotable in relation to the device 502, as shown in FIG. 7. It should be appreciated that the collapsible extension 504 may be pivoted in order to support the image capture device 502 in either a portrait or landscape orientation.

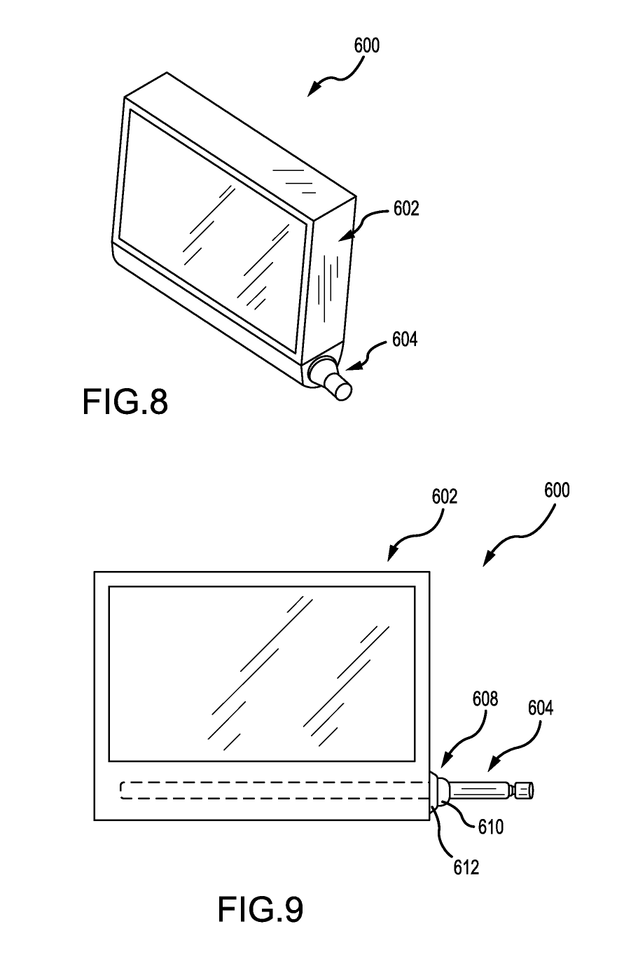

FIG. 8 illustrates an image capture device incorporating a collapsible extension 600 according to yet another representative embodiment. In this embodiment the collapsible extension 604 is housed within the image capture device or case 602, as shown in the figure. Collapsible extension 604 includes a plurality of telescoping segments similar to that described above with respect to FIGS. 5-7 and is interconnected to the image capture device 602 by ball joint 608. As shown in FIG. 9, the collapsible segments extend through the ball joint 608 when in the collapsed configuration wherein the collapsible segments are housed inside the device or case 602. Therefore, in this embodiment the collapsible segments are pivotable in relation to the device or case 602 only when in the extended configuration. Ball joint 608 may include a ball member 610 and a flange 612 that is operative to exert friction against the ball member 610 in order to maintain the pivotable position of the collapsible extension 604. One of ordinary skill in the art will recognize that the collapsible extension is similar to a telescoping antenna. Furthermore, the ball joint arrangement associated with the telescoping collapsible extension is similar to that associated with telescoping antennas. For example, suitable representative ball joint designs are shown and described in U.S. Pat. Nos. 3,241,144 and 3,241,149, the disclosures of which are hereby incorporated by reference in their entireties.

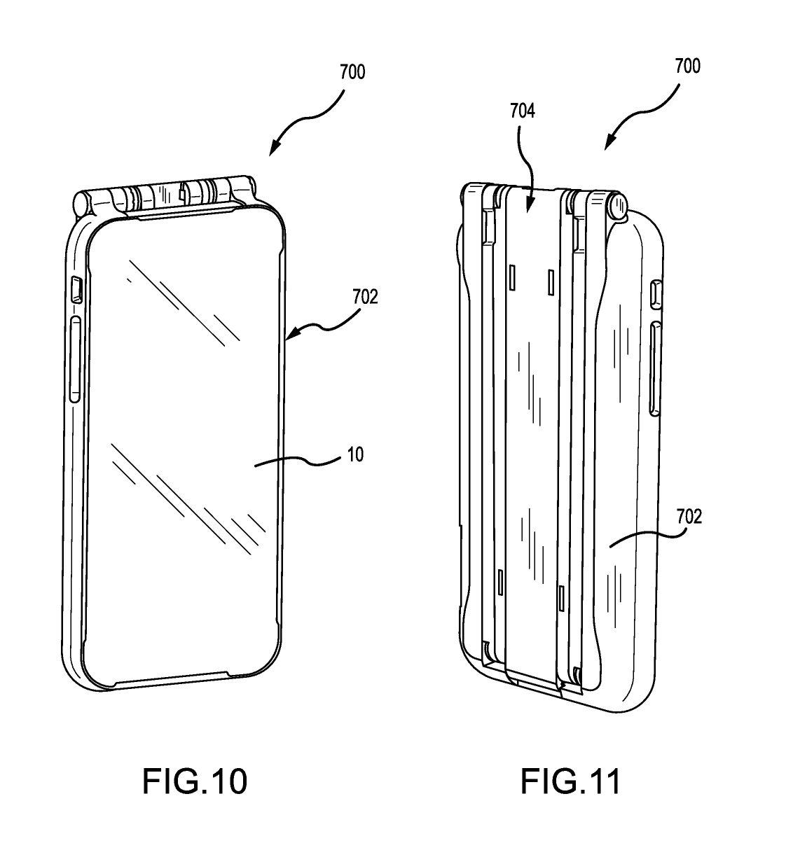

FIG. 10 illustrates an image capture device case 700 according to a representative embodiment. In this embodiment, the image capture device is a mobile phone 10 that is housed in cover 702. As shown in FIG. 11, case 700 includes a cover 702 and incorporates a collapsible extension 704. When in the collapsed configuration, extension 704 stacks against the case in a nested arrangement.

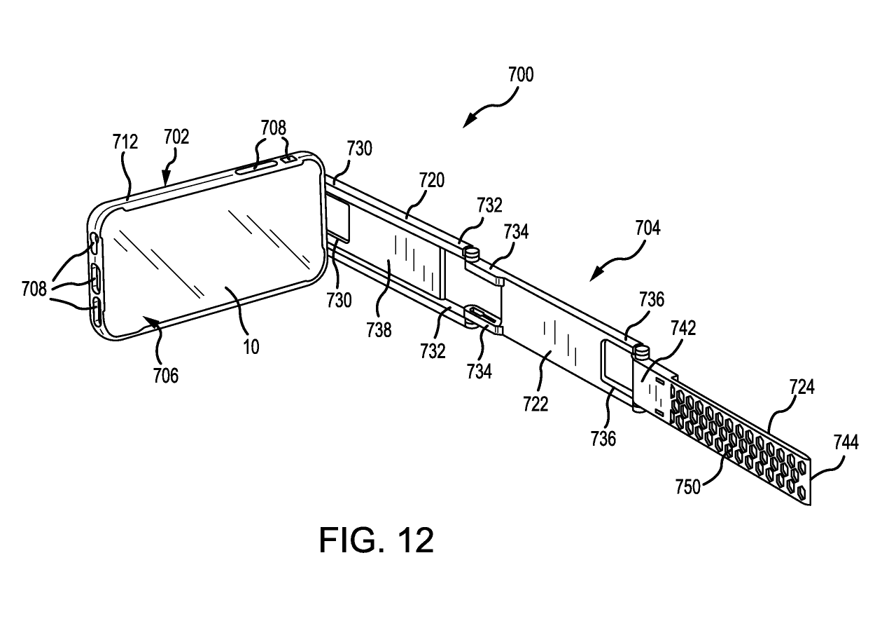

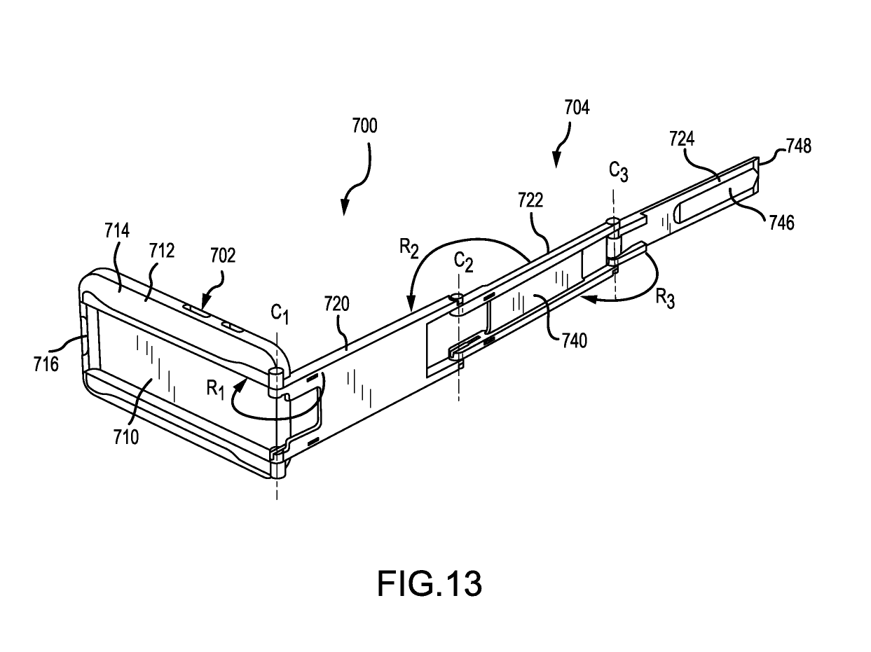

Collapsible extension 704 is moveable between a collapsed configuration (e.g., FIGS. 10 and 11) and an extended configuration, such as shown in FIGS. 12 and 13. With reference to FIG. 12, cover 702 includes a surrounding sidewall 712 forming a device opening 706 that is sized and configured to receive an image capture device, such as mobile phone 10. Surrounding sidewall 712 may include suitable apertures 708 to facilitate accessing the mobile devices' buttons, speakers, headphone jacks, power plugs, etc.

Collapsible extension 704 includes three hinged segments 720, 722, and 724 that are moveable with respect to each other between the collapsed configuration and the extended configuration. First segment 720 includes proximal arms 730 that are rotatably coupled to cover 702. First segment 720 also includes distal arms 732 that are rotatably coupled to the second segment 722. Similarly, second segment 722 includes proximal arms 734 coupled to distal arms 732 and distal arms 736 that are rotatably coupled to the third segment 724. Third segment 724 includes a proximal end portion 742 that is rotatably coupled to distal arms 736 of the second segment 722. Third segment 724 also includes a distal end portion 744. In some embodiments, third segment 724 can include a pattern 750 that provides a grip to further facilitate expanding and grasping the extension 704. Other components, such as first and second segments 720, 722 and/or cover 702 can also include grip patterns.

As shown in FIG. 12, first segment 720 includes a recess 738 that is sized and configured to receive second segment 722 in a nested configuration. Moving to FIG. 13, it can be appreciated that second segment 722 includes a recess 740 that is sized and configured to receive the third segment 724 in a nested configuration when the extension 704 is in the collapsed configuration. Cover 702 includes a cover panel 714 from which surrounding sidewall 712 extends. Cover panel 714 includes a recessed region 710 that is sized and configured to receive segments 720, 722, and 724 when in the collapsed configuration. Third segment 724 includes an access recess 746 and a chamfer 748, which facilitate unfolding the extension 704 from the collapsed configuration. Recessed region 710 includes a notch 716 positioned to cooperate with the chamfer 748 and access recess 746 of the third segment 724 to facilitate extending the extension 704.

First segment 720 is rotatably coupled to the cover 702 adjacent the recessed region 710 and rotates with respect to the cover 702 about a first axis C₁. Second segment 722 is rotatably coupled to the first segment 720 about a second axis C₂. Third segment 724 is rotatably coupled to second segment 722 about a third axis C₃. To move the extension 704 from the extended configuration to the collapsed configuration, first segment 720 is rotated about axis C₁ in a first direction R₁ approximately 270°. Segment 722 is rotated about axis C₂ in a second direction R₂, opposite R₁, approximately 180°. Segment 724 is rotated about axis C₃ in a third direction R₃, opposite R₂, approximately 180°. Accordingly, the three segments 720, 722, and 724 rotate with respect to each other in alternating directions. Extending the extension 704 can be performed by reversing the rotations described above for collapsing the extension. It should be appreciated that axes C₁, C₂, and C₃ are substantially parallel to each other.

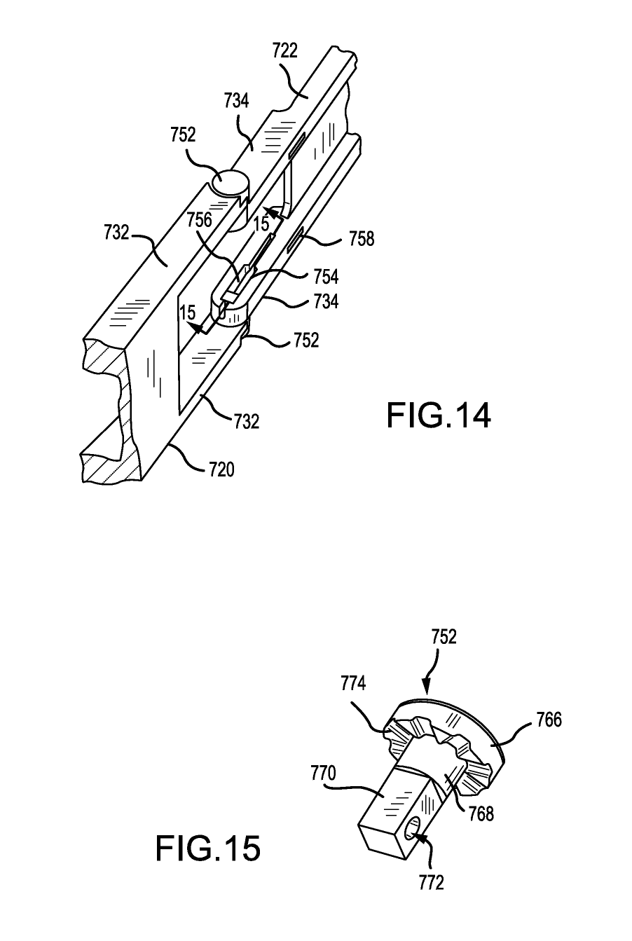

The segments 720, 722, and 724 are hinged to each other by pairs of corresponding pins. FIG. 14 specifically illustrates the hinged connection between first segment 720 and second segment 722. Pins 752 extend through distal arms 732 and proximal arms 734 of the first segment 720 and the second segment 722, respectively. Each pin 752 extends through distal arm 732, proximal arm 734, and into a pocket 756. Pin 752 is retained in position by a spring wire retainer 754 extending through pin 752 and into pocket 756. Spring wire retainer 754 is retained in pocket 756 by an interference fit with slot 758, which intersects orthogonally with pocket 756.

Referring to FIG. 15, pin 752 includes a head 766, a bearing portion 768, and a peg portion 770. Peg portion 770 includes a cross-aperture 772 sized and configured to receive spring wire 754 therethrough. Pin 752 includes a plurality of teeth 774 disposed on the underside of head 766. Returning briefly to FIG. 14, it can be appreciated that peg 770 is registered in pocket 756. Accordingly, pin 752 rotates with arm 734.

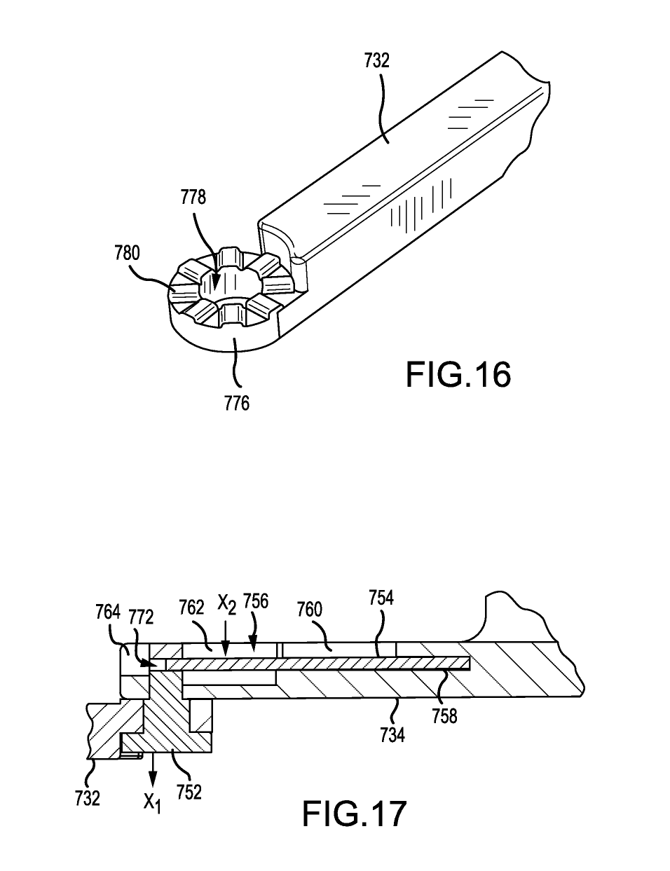

As shown in FIG. 16, distal arm 732 includes a knuckle 776 and a pin aperture 778 sized to receive the bearing shaft portion 768 of pin 752. Knuckle 776 includes a plurality of teeth 780 that engage the plurality of teeth 774 of pin 752. Teeth 774 and 780 cooperate to maintain the angular position of each segment with respect to the other segments. As arm 732 is rotated with respect to arm 734 and pin 752, teeth 774 must pass over corresponding teeth 780 thereby causing pin 752 to displace in direction X₁, as shown in FIG. 17. Thus, spring wire 754 acts to return pin 752 to a locked position where teeth 774 and 780 interlock. Pocket 756 includes a guide region 760, a clearance region 762, and an assembly slot 764. Guide region 760 facilitates the insertion of spring wire 754 through cross-drill 772 and into slot 758 where it is retained. Assembly slot 764 allows the spring wire retainer 754 to be inserted into the assembly. Clearance portion 762 allows spring wire 754 to move or bend in direction X₂ corresponding with movement X₁ of pin 752.

In some embodiments, the components of the image capture device case 700 are comprised of injection molded plastic, such as segments 720, 722, and 724, for example. However, any suitable material and process may be used to construct the image capture device case 700. In some embodiments, the cover 702 can be comprised of rubber or plastic. In other embodiments the segments 720, 722, and 724 can be comprised of metal, such as aluminum.

Additional collapsible extensions for use with camera phones, camera phone cases incorporating collapsible extensions, and camera phones or other image capture devices incorporating collapsible extensions are disclosed herein. For example, an image capture device case can attach to a camera phone or other image capture device and incorporates a collapsible extension. In an embodiment, an image capture device case incorporating a collapsible extension comprises a case configured to at least partially surround an image capture device and a collapsible extension attached to the case and including two or more collapsible segments moveable between a collapsed configuration and an extended configuration. In some embodiments, the collapsible extension is removably attached to the case. An image capture device includes a collapsible extension attached to the device. In an embodiment, an image capture device incorporating a collapsible extension comprises an image capture device and a collapsible extension attached to the device and including two or more collapsible segments moveable between a collapsed configuration and an extended configuration. In some embodiments, the collapsible extension is removably attached to the device. In some embodiments, the two or more collapsible segments rotate with respect to each other. In some embodiments, the two or more collapsible segments rotate with respect to each other in a scissor-like fashion. In other embodiments, the two or more collapsible segments rotate with respect to each other in a hinge-like fashion. In some embodiments, the segments comprise nested cylindrical segments arranged to telescope with respect to each other. Some embodiments further comprise a ball joint interconnecting the collapsible segments to the device or case, whereby the collapsible segments are pivotable in relation to the device or case. In some embodiments, the collapsible segments are pivotable in relation to the device or case only when in the extended configuration, wherein the collapsible segments extend through the ball joint when in the collapsed configuration. In some embodiments, the collapsible segments are housed inside the device or case when in the collapsed configuration.

Accordingly, the collapsible extension along with image capture device and case incorporating the same have been described with some degree of particularity directed to the representative embodiments. It should be appreciated, however, that modifications or changes may be made to the representative embodiments without departing from the inventive concepts contained herein. Certain aspects of the disclosure described in the context of particular embodiments may be combined or eliminated in other embodiments. Thus, the present disclosure and associated technology can encompass other embodiments not expressly shown or described herein.

1. A collapsible extension for use with an image capture device, comprising:
two or more hinged segments moveable with respect to each other between a collapsed configuration and an extended configuration, wherein at least one of the two or more hinged segments includes a relief to receive the other of the two or more hinged segments therein, whereby the two or more hinged segments nest together when in the collapsed configuration; and
wherein one of the two or more hinged segments is attached to a cover sized and configured to at least partially surround an image capture device.

2-3. (canceled)

4. The collapsible extension of claim 1, wherein the cover includes a recessed region sized and configured to receive the two or more hinged segments when in the collapsed configuration.

5. (canceled)

6. The collapsible extension of claim 1, further comprising three hinged segments.

7. The collapsible extension of claim 6, wherein the three hinged segments rotate in alternating directions and nest together when in the collapsed configuration.

8. An image capture device case incorporating a collapsible extension, comprising:
a cover configured to at least partially surround an image capture device; and
a collapsible extension coupled to the cover and including first and second collapsible segments rotatable between a collapsed configuration and an extended configuration, wherein the first collapsible segment includes a relief to receive the second collapsible segment therein, whereby
the first and second collapsible segments nest together when in the collapsed configuration; and
wherein the cover includes a recessed region sized and configured to receive the first and second collapsible segments when in the collapsed configuration.

9. The image capture device case of claim 8, wherein the collapsible segments are hinged to each other.

10. The image capture device case of claim 8, wherein the collapsible segments stack against the cover when in the collapsed configuration.

11. (canceled)

12. The image capture device case of claim 9, further comprising three hinged segments.

13. The image capture device case of claim 12, wherein the three hinged segments rotate in alternating directions and nest together when in the collapsed configuration.

14. The image capture device case of claim 12, wherein the three hinged segments are each coupled to each other by a corresponding pair of pins.

15. An image capture device case, comprising:
a cover, comprising:
a cover panel;
a surrounding sidewall extending from the cover panel to form a device opening sized and configured to receive an image capture device; and
a recessed region formed in the cover panel opposite the device opening; and
an extension moveable between a collapsed configuration and an extended configuration, comprising:
a first segment, including a first relief, rotatably coupled to the cover adjacent the recessed region, wherein the first segment is sized to fit at least partially within the recessed region when in the collapsed configuration;
a second segment rotatably coupled to the first segment and including a second relief, wherein the second segment is sized to fit at least partially within the first relief when in the collapsed configuration; and
a third segment rotatably coupled to the second segment, wherein the third segment is sized to fit at least partially within the second relief when in the collapsed configuration.

16. The image capture device case of claim 15, wherein the first, second, and third segments are hinged to each other.

17. The image capture device case of claim 15, wherein the first segment rotates with respect to the cover about a first axis, the second segment rotates with respect to the first segment about a second axis, and the third segment rotates with respect to the second segment about a third axis.

18. The image capture device case of claim 17, wherein the first, second, and third axes are parallel with respect to each other.

19. The image capture device case of claim 17, wherein at least the cover, the first segment, and the second segment are each coupled to each other by a corresponding pair of pins extending along the first and second axes, respectively.

20. The image capture device case of claim 19, wherein each pin includes a plurality of teeth engaged with corresponding mating teeth formed on the case and the first segment.
